(19) United States
(12) Patent Application Publication
(10) Pub. No.: US 2024/0077510 A1
(43) Pub. Date: Mar. 7, 2024

(54) HIGH-PRECISION VEHICLE VELOCITY CALCULATION METHOD

(71) Applicant: HUIZHOU DESAY SV AUTOMOTIVE CO., LTD., Guangdong (CN)

(72) Inventor: Ye LIN, Guangdong (CN)

(21) Appl. No.: 18/270,504

(22) PCT Filed: Jun. 25, 2021
(86) PCT No.: PCT/CN2021/102532

§ 371 Date: Jun. 30, 2023

(30) Foreign Application Priority Data
Feb. 2, 2021 (CN) 202110140353.1

(51) Int. Cl. G01P 3/00; G06N 5/022

(52) U.S. Cl. CPC G01P 3/00; G06N 5/022

(57) ABSTRACT

Disclosed is a high-precision vehicle velocity calculation method. The method includes: calculating a tire slip rate at the current moment, determining whether the slip rate is smaller than a threshold value, if so, continuing to correct a tire radius and acceleration; establishing a relational expression for tire angular acceleration, an acceleration measured value, an acceleration offset and a tire radius at the current moment; building a system prediction model; building a measurement system model; substituting the system prediction model and the measurement system model into a Kalman filter prediction model, to acquire a corrected value of the tire radius at the current moment and a corrected value of the acceleration offset at the current moment; and calculating a vehicle velocity at the current moment based on the corrected value of the tire radius at the current moment and the corrected value of the acceleration offset at the current moment.

### BACKGROUND OF THE INVENTION

The present disclosure relates to the technical field of vehicles, in particular to a high-precision vehicle velocity calculation method.

Vehicle control algorithms of an advanced driving assistant system (ADAS) and an automatic driving system need to be established on the basis of accurate vehicle velocity calculation and acceleration measurement, so as to accurately control vehicle behaviors under various driving scenarios. For example, for an adaptive cruise control (ACC) function, if there is an error in the measurement or calculation of the vehicle velocity or acceleration, the error may be directly reflected in control over a distance between a vehicle and a vehicle ahead. The inaccuracy of the distance control may even cause collisions and result in serious traffic accidents.

At present, the most common parameters used to calculate the vehicle velocity of a mass-produced vehicle are a tire velocity measured by a wheel velocity sensor and acceleration measured by an accelerometer. The mainstream practice is to optimize a non-driven wheel velocity or to superimpose vehicle velocities calculated based on the wheel velocity and the acceleration (as described in the patent No. TW106125538), but whether it is to optimize the wheel velocity or to superimpose the wheel velocity and the acceleration, these two methods do not take into account possible errors in measured values of the tire radius and the acceleration. Because the tire will inevitably have friction with the ground in the running process of a vehicle, the tire radius must be gradually smaller, and if the wheel velocity is uniformly calculated with the factory radius of the tire, a certain error may be inevitably caused. In addition, the measurement of the acceleration may also have errors under the action of inertia in the case of uphill, downhill, rapid acceleration or rapid deceleration. However, if the vehicle velocity is estimated with an unoptimized tire radius and acceleration measured value, an estimation result is inaccurate and has low reference value.

In order to overcome the defects of an existing vehicle velocity estimation method, the present application provides a high-precision vehicle velocity calculation method to correct the tire radius and the acceleration measured value of a mass-produced vehicle, so as to improve the calculation accuracy of the vehicle velocity.

### BRIEF SUMMARY OF THE INVENTION

In order to overcome the above defects, the present disclosure provides a high-precision vehicle velocity calculation method. The method includes:
calculating a tire slip rate at the current moment, determining whether the slip rate is less than a threshold value, if the slip rate is less than the threshold value, continuing to correct a tire radius and acceleration, otherwise, stopping a correction process;
establishing a relational expression for tire angular acceleration, an acceleration measured value, an acceleration offset and a tire radius at the current moment;
building a system prediction model based on the relational expression;
building a measurement system model based on the relational expression;
substituting the system prediction model and the measurement system model into a Kalman filter prediction model, to acquire a corrected value of the tire radius at the current moment and a corrected value of the acceleration offset at the current moment; and
calculating a vehicle velocity at the current moment based on the corrected value of the tire radius at the current moment and the corrected value of the acceleration offset at the current moment.

Further, the step of calculating the tire slip rate includes:
acquiring a tire linear velocity of a vehicle at the current moment;
acquiring a center point moving velocity of the vehicle at the current moment;
acquiring a difference between the tire linear velocity and the center point moving velocity;
if the vehicle is in an accelerating state at the current moment, taking the difference between the tire linear velocity and the center point moving velocity as the numerator and the tire linear velocity as the denominator to obtain a ratio of the difference to the tire linear velocity, and using the ratio as the slip rate; and
if the vehicle is in a decelerating state at the current moment, taking the difference between the tire linear velocity and the center point moving velocity as the numerator and the center point moving velocity as the denominator to obtain a ratio of the difference to the center point moving velocity, and using the ratio as the slip rate.

Further, the step of acquiring the tire linear velocity of the vehicle at the current moment includes:
acquiring a tire angular velocity at the current moment;
acquiring a tire factory radius; and
taking a product of the tire angular velocity at the current moment and the tire factory radius as the tire linear velocity at the current moment.

Further, when the slip rate is greater than or equal to the threshold value and the correction process is stopped, the method further includes:
calculating the vehicle velocity at the current moment based on a corrected value of the tire radius at the previous moment and a corrected value of the acceleration offset at the previous moment.

Further, in the step of establishing the relational expression for the tire angular acceleration, the acceleration measured value, the acceleration offset and the tire radius at the current moment, the relational expression is as follows:

$${\dot{ω}}_{tire} ( i ) = \frac{{a}_{k} ( i ) - ε ( i )}{r}$$

where \dot{w}ₜᵢᵣₑ(i) denotes the tire angular acceleration, aₖ(i) denotes the acceleration measured value, ε(i) denotes the acceleration offset, and r denotes the tire radius.

Further, after the step of establishing the relational expression for the tire angular acceleration, the acceleration measured value, the acceleration offset and the tire radius at the current moment, and before the step of building the system prediction model based on the relational expression, the method further includes a step of formula rewriting:
rewriting the established relational expression into a matrix formula, the matrix formula being as follows:

$${\dot{ω}}_{tire} ( i ) = [ \begin{matrix}{a}_{k} ( i ) & - 1 ] [ \begin{matrix}\frac{1}{r} \\ \frac{ε ( i )}{r}\end{matrix} ]\end{matrix}$$

where \dot{w}ₜᵢᵣₑ(i) denotes the tire angular acceleration, aₖ(i) denotes the acceleration measured value, ε(i) denotes the acceleration offset, and r denotes the tire radius.

Further, the step of building the system prediction model based on the relational expression includes:
taking

$$[ \begin{matrix}\frac{1}{r} \\ \frac{ε}{r}\end{matrix} ]$$

as a prediction variable X in the system prediction model, thereby setting

$$X = [ \begin{matrix}\frac{1}{r} \\ \frac{ε}{r}\end{matrix} ] ;$$

and
establishing, based on the matrix formula and a standard formula of a prediction model, the system prediction model specifically as follows:

$$[ \begin{matrix}\frac{1}{r} ( i ) \\ \frac{ε}{r} ( i )\end{matrix} ] = [ \begin{matrix}1 & 0 \\ 0 & 1\end{matrix} ] \cdot [ \begin{matrix}\frac{1}{r} ( i - 1 ) \\ \frac{ε}{r} ( i - 1 )\end{matrix} ] + [ \begin{matrix}{n}_{1} ( i ) \\ {n}_{2} ( i )\end{matrix} ]$$

where

$$[ \begin{matrix}\frac{1}{r} ( i ) \\ \frac{ε}{r} ( i )\end{matrix} ]$$

denotes X at a moment i,

$$[ \begin{matrix}\frac{1}{r} ( i - 1 ) \\ \frac{ε}{r} ( i - 1 )\end{matrix} ]$$

denotes X at a moment i−1, and

$$[ \begin{matrix}{n}_{1} ( i ) \\ {n}_{2} ( i )\end{matrix} ]$$

denotes prediction system noise.

Further, the step of building the measurement system model based on the relational expression includes:
taking \dot{w}ₜᵢᵣₑ(i) as a measured value Z in the measurement system model, thereby setting Z=\dot{w}ₜᵢᵣₑ(i); and
establishing, based on the matrix formula and a standard formula of a measurement model, the measurement system model specifically as follows:

$${\dot{ω}}_{tire} ( i ) [ \begin{matrix}{a}_{k} ( i ) & - 1 ]\end{matrix} [ \begin{matrix}\frac{1}{r} \\ \frac{ε}{r}\end{matrix} ] + v ( i )$$

where v(i) denotes measurement system noise.

Further, the standard formula of the prediction model is as follows:

X(i)=A·X(i−1)+B·U(i)+N(i)
where X(i) denotes a state of X at the moment i, X(i−1) denotes a state of X at the moment i−1, A and B denote system parameters, U(i) denotes a system variable input at the moment i, and N(i) denotes system noise; and
the standard formula of the measurement model is as follows:

Z(i)=H·X(i)+V(i)
where Z(i) denotes a measured value at the moment i, X(i) denotes the state of X at the moment i, H denotes a system parameter, and V(i) denotes system noise.

Further, the step of calculating the vehicle velocity at the current moment based on the corrected value of the tire radius at the current moment and the corrected value of the acceleration offset at the current moment includes:
acquiring a sum of the acceleration measured value at the current moment and the corrected value of the acceleration offset, and taking the sum as a corrected value of the acceleration at the current moment; and
multiplying the corrected value of the acceleration at the current moment with a sampling period to obtain a product, and adding the product to a vehicle velocity at the previous moment to obtain a sum, the sum being the vehicle velocity at the current moment.

Compared with the prior art, the present disclosure has the following beneficial effects:

The present disclosure provides the high-precision vehicle velocity calculation method. In the vehicle velocity calculation method, the relational expression of the tire angular acceleration, the acceleration measured value, the acceleration offset and the tire radius at the same moment is established, the relational expression is rewritten into the matrix formula, then the system prediction model and the measurement system model are built, and the system prediction model and the measurement system model are substituted into the Kalman filter prediction model to obtain the corrected value of the tire radius and the corrected value of the acceleration offset. The obtained corrected value of the tire radius and the corrected value of the acceleration offset are highly consistent with an actual tire radius and an actual acceleration offset at the current moment, so that the vehicle velocity calculated based on the corrected value of the tire radius and the corrected value of the acceleration offset basically matches an actual vehicle velocity at the current moment, the error is small, and precision is high, which, for an advanced driving assistant system and an autonomous driving system, have a high reference value, facilitate the improvement of driving safety, reduce the probability of traffic accidents, and have a very high use value.

### BRIEF DESCRIPTION OF THE DRAWINGS

FIG. 1 shows a high-precision vehicle velocity calculation method in Embodiment 1.

FIG. 2 shows a curve comparison chart of an acceleration measured value, a corrected value of acceleration, and an uncorrected acceleration measured value acquired by GPS in Embodiment 1.

FIG. 3 shows a curve comparison chart of a vehicle velocity at the current moment, a corrected current vehicle velocity, and an uncorrected current vehicle velocity acquired by GPS in Embodiment 1.

The accompanying drawings are for illustrative purposes only and are not to be construed as limiting the patent. In order to better illustrate the embodiments, some parts of the accompanying drawings may be omitted, enlarged or reduced and do not represent actual dimensions. It may be appreciated by those skilled in the art that some well-known structures and their descriptions may be omitted from the accompanying drawings. The same or similar reference numerals correspond to the same or similar parts. The terms used in the accompanying drawings to describe positional relationships are for illustrative purposes only and are not to be construed as limiting the patent.

### DETAILED DESCRIPTION OF THE INVENTION

The preferred embodiments of the present disclosure are described in detail below, so that the advantages and features of the present disclosure may be more easily understood by those skilled in the art and thus provide a clearer definition of the scope of protection of the present disclosure.

### Embodiment 1

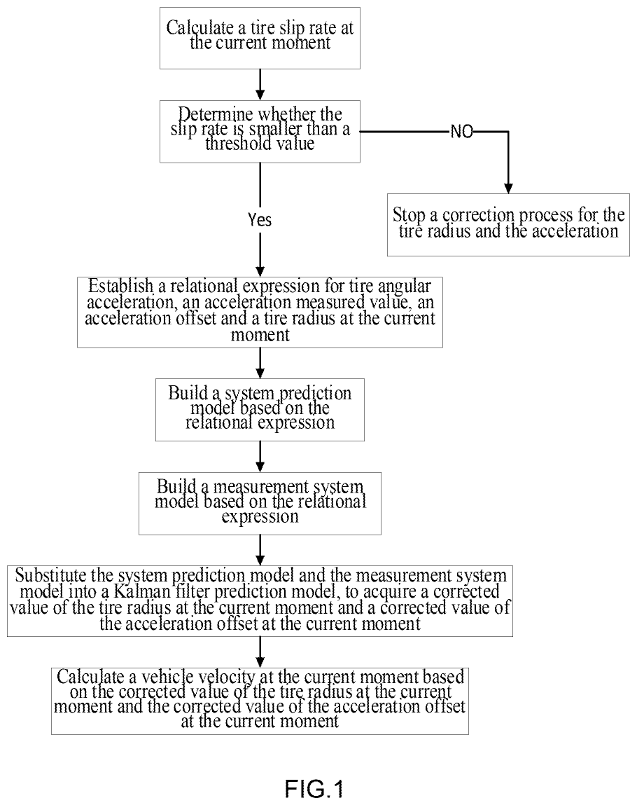

As shown in FIG. 1 to FIG. 3, this embodiment provides a high-precision vehicle velocity calculation method. The implementation of the method is based on a wheel velocity sensor installed on a vehicle and an accelerometer installed on the vehicle. The wheel velocity sensor is used to acquire a rotation angular velocity of a tire (a tire linear velocity may be calculated based on the rotation angular velocity of the tire), and the accelerometer is used to detect an acceleration value of the vehicle to obtain an acceleration measured value of the vehicle.

The high-precision vehicle velocity calculation method includes the following steps:

101: Calculate a tire slip rate at the current moment, determine whether the slip rate is less than a threshold value, if the slip rate is less than the threshold value, continue to correct a tire radius and acceleration, otherwise, stop a correction process.

In the specific implementation process, a tire linear velocity Vₜᵢᵣₑ of the vehicle at the current moment needs to be acquired firstly, and then a center point moving velocity V_{CG} (that is, a vehicle velocity) of the vehicle at the current moment is acquired. A difference (Vₜᵢᵣₑ-V_{CG}) between the tire linear velocity and the center point moving velocity is then acquired. Then, according to whether the vehicle is in an accelerating state or a decelerating state at the current moment, a specific calculation method used to acquire the slip rate of the vehicle is determined. Generally, if the vehicle is in the accelerating state at the current moment, the difference between the tire linear velocity and the center point moving velocity is taken as the numerator and the tire linear velocity is taken as the denominator to obtain a ratio of the difference to the tire linear velocity, and the ratio is used as the slip rate. That is, when the vehicle is in the accelerating state, S (slip rate)=(Vₜᵢᵣₑ-V_{CG})/Vₜᵢᵣₑ. If the vehicle is in the decelerating state at the current moment, the difference between the tire linear velocity and the center point moving velocity is taken as the numerator and the center point moving velocity is taken as the denominator to obtain a ratio of the difference to the center point moving velocity, and the ratio is used as the slip rate. That is, when the vehicle is in the decelerating state at the current moment, S (slip rate)=(Vₜᵢᵣₑ-V_{CG})V_{CG}.

In this technical solution, in order to acquire the tire linear velocity of the vehicle at the current moment, a tire angular velocity at the current moment generally needs to be acquired firstly, the tire angular velocity being acquired by the wheel velocity sensor. Then the tire factory radius is acquired, which is generally provided directly by a manufacturer. Finally, a product of the tire angular velocity at the current moment and the tire factory radius is taken as the tire linear velocity at the current moment. Sometimes, an electronic stability control (ESC) system may directly transmit the angular velocity of four tires to a controller area network (CAN), and a relevant calculation module calculates an average tire linear velocity based on the angular velocity of the four tires and the tire factory radius. Of course, ESC may also directly convert the angular velocity of the tires into the tire linear velocity and then transmit the tire linear velocity to the CAN, which is not limited here.

This technical solution mainly aims at the vehicle velocity estimation of a mass-produced vehicle. As the mass-produced vehicle is generally provided with no GPS, the vehicle velocity may not be directly acquired through GPS. In this case, in order to calculate the slip rate of the vehicle and make an accurate determination on the subsequent correction, the vehicle velocity at the current moment needs to be calculated based on the tire linear velocity and the acceleration of the vehicle, where the acceleration of the vehicle is obtained by an accelerating vehicle. Specifically, the calculation formula for estimating the vehicle velocity based on the tire linear velocity and the acceleration of the vehicle is as follows:

$${V}_{CG} ( i ) = \frac{1}{{K}_{s}} \{ {k}_{rr} {V}_{rr} + {k}_{lr} {V}_{lr} + {k}_{rf} {V}_{rf} + {k}_{lf} {V}_{lf} + {k}_{acc} [ {V}_{CG} ( i - 1 ) + a ( i ) * T ] \}$$

where V_{CG}(i) denotes a vehicle velocity at a moment i, V_{CG}(i−1) denotes a vehicle velocity at a moment i−1, Vᵣᵣ, Vₗᵣ, V_{rf} and V_{lf} denote tire linear velocities of four tires respectively, Kᵣᵣ, Kₗᵣ, K_{rf} and K_{lf} denote weights of the tires, a(i) denotes acceleration at the moment i, T denotes a sampling period, K_{ace} denotes an acceleration weight, and Kₛ=Kᵣᵣ+Kₗᵣ+K_{rf}+K_{lf}+K_{acc}. The calculation of the slip rate may be completed based on the above estimated vehicle velocity and the calculated tire linear velocity.

Preferably, when the slip rate is greater than or equal to the threshold value and the correction process is stopped, a corrected value of the tire radius at a previous moment and a corrected value of the acceleration offset at the previous moment may also be called, and the vehicle velocity at the current moment is calculated based on the corrected value of the tire radius at the previous moment and the corrected value of the acceleration offset at the previous moment. In this embodiment, the threshold value of the slip rate is generally set to range from 3% to 8%, preferably, 5%. That is, when the slip rate S calculated above is less than the threshold value, correction of the acceleration and the tire radius may continue. If the slip rate S is greater than or equal to the threshold value, the correction of the acceleration may be suspended, and the vehicle velocity is estimated with the corrected value of the tire radius at the previous moment and the corrected value of the acceleration offset at the previous moment. Based on many test observations, tires may not keep slipping for a long time in the general road environment, there is still a lot of opportunities to correct the acceleration, and the correction by this algorithm is mainly to eliminate errors caused by a slope on acceleration measurement. The slope where the vehicle is located at the moment of slipping generally does not change much compared with the previous moment. Even if the slope where the vehicle runs changes during the period of time when the acceleration correction is stopped, a calculation result is still more accurate than no correction at all.

102: Establish a relational expression for tire angular acceleration, an acceleration measured value, an acceleration offset and a tire radius at the current moment.

In the process of establishing the relational expression, a relationship among the tire angular acceleration, the acceleration measured value, the acceleration offset and the tire radius need to be preliminarily analyzed. Since there are two main sources for vehicle velocity calculation, one is the tire linear velocity, and the other is the acceleration of the center of the vehicle, the two source parameters must be optimized algorithmically in order to make the vehicle velocity estimation accurate. The known phenomenon is that the measurement of the acceleration may be affected by the slope where the vehicle runs, so the acceleration may be more suitable for use through a system prediction model. Another parameter that may affect the vehicle velocity calculation is the tire radius. Generally, the measurement of the tire linear velocity firstly starts from an angular velocity ωₜᵢᵣₑ, and the tire linear velocity Vₜᵢᵣₑ=ωₜᵢᵣₑ·r. Thus, it may be seen that an error of r may also affect the tire linear velocity. ε(i)=aₖ(i)−a(i), where ε(i) denotes the acceleration offset (an error between the measured value and an actual value), aₖ(i) denotes the acceleration measured value, and a(i) is regarded as an actual acceleration value at the moment i, that is, the acceleration value to be required.

Assuming that when the vehicle is driving on the slope, the vehicle acceleration value acquired by the accelerometer has been affected by the slope, the acceleration needs to be acquired through the differential of the tire linear velocity in order to correct the acceleration, which is thus used as a reference for another acceleration source. The acceleration obtained from the differential of the tire linear velocity is denoted as aₜᵢᵣₑ(i), and based on the physical formula, it may be known that the relationship between the tire linear acceleration aₜᵢᵣₑ(i) and the tire angular acceleration \dot{w}ₜᵢᵣₑ(i) is aₜᵢᵣₑ(i)=\dot{w}ₜᵢᵣₑ·r. Then, assuming that in a vehicle model, the tire linear acceleration aₜᵢᵣₑ(i) is equal to the vehicle center acceleration a(i), and the acceleration offset ε(i) is substituted into, the following correlation formula may be obtained:

$${\dot{ω}}_{tire} ( i ) = \frac{{a}_{tire} ( i )}{r} = \frac{a ( i )}{r} = \frac{{a}_{k} ( i ) - ε ( i )}{r}$$

Then, the established relational expression is derived as follows:

$${\dot{ω}}_{tire} ( i ) = \frac{{a}_{k} ( i ) - ε ( i )}{r}$$

where \dot{w}ₜᵢᵣₑ(i) denotes the tire angular acceleration, aₖ(i) denotes the acceleration measured value, ε(i) denotes the acceleration offset, and r denotes the tire radius.

In order to facilitate the subsequent establishment of the system prediction model and the measurement system model and successful substitution of the models into a Kalman filter prediction model, the established relational expression above further needs to be rewritten into a matrix formula. The matrix formula is specifically as follows:

$${\dot{ω}}_{tire} ( i ) = [ \begin{matrix}{a}_{k} ( i ) & - 1 ]\end{matrix} [ \begin{matrix}\frac{1}{r} \\ \frac{ε ( i )}{r}\end{matrix} ]$$

where in the matrix formula, \dot{w}ₜᵢᵣₑ(i) denotes the tire angular acceleration, aₖ(i) denotes the acceleration measured value, ε(i) denotes the acceleration offset, and t denotes the tire radius.

103: Build the system prediction model based on the relational expression.

In the process of establishing the system prediction model, a prediction variable needs to be determined firstly. In this embodiment,

$$[ \begin{matrix}\frac{1}{r} \\ \frac{ε}{r}\end{matrix} ]$$

is taken as the prediction variable X in the system prediction model, that is,

$$X = [ \begin{matrix}\frac{1}{r} \\ \frac{ε}{r}\end{matrix} ]$$

is set. Then, the system prediction model is established based on the matrix formula and a standard formula of a prediction model. The system prediction model is specifically as follows:

$$[ \begin{matrix}\frac{1}{r} ( i ) \\ \frac{ε}{r} ( i )\end{matrix} ] = [ \begin{matrix}1 & 0 \\ 0 & 1\end{matrix} ] \cdot [ \begin{matrix}\frac{1}{r} ( i - 1 ) \\ \frac{ε}{r} ( i - 1 )\end{matrix} ] + [ \begin{matrix}{n}_{1} ( i ) \\ {n}_{2} ( i )\end{matrix} ]$$

where in the system prediction model,

$$[ \begin{matrix}\frac{1}{r} ( i ) \\ \frac{ε}{r} ( i )\end{matrix} ]$$

denotes X at the moment i,

$$[ \begin{matrix}\frac{1}{r} ( i - 1 ) \\ \frac{ε}{r} ( i - 1 )\end{matrix} ]$$

denotes X at the moment i−1, and

$$[ \begin{matrix}{n}_{1} ( i ) \\ {n}_{2} ( i )\end{matrix} ]$$

denotes prediction system noise.

In this technical solution, the standard formula of the prediction model is as follows:

X(i)=A·X(i−1)+B·U(i)+N(i)

where in the standard formula of the prediction model, X(i) denotes a state of X at a moment i, X(i−1) denotes a state of X at a moment i−1, A and B denote system parameters, U(i) denotes a system variable input at the moment i (in this technical solution, U=0), and N(i) denotes system noise.

104: Build the measurement system model based on the relational expression.

In the process of establishing the measurement system model, a measured value needs to be determined firstly. In this embodiment, \dot{w}ₜᵢᵣₑ(i) is taken as a measured value Z in the measurement system model, that is, Z=\dot{w}ₜᵢᵣₑ(i) is set. Then, the measurement system model is established based on the matrix formula and a standard formula of a measurement model, which is specifically as follows:

$$\begin{matrix}{\dot{ω}}_{tire} ( i ) = [ {a}_{k} ( i ) & - 1 ]\end{matrix} [ \begin{matrix}\frac{1}{r} \\ \frac{ε}{r}\end{matrix} ] + v ( i )$$

where in the measurement system model, v(i) denotes measurement system noise.

In this technical solution, the standard formula of the measurement model is as follows:

Z(i)=H·X(i)±+V(i)

where Z(i) denotes a measured value at a moment i, X(i) denotes the state of X at the moment i, H denotes a system parameter (H=[aₖ(i)−1]) and denotes system noise.

105: Substitute the system prediction model and the measurement system model into the Kalman filter prediction model, to acquire a corrected value of the tire radius at the current moment and a corrected value of the acceleration offset at the current moment

Specifically, the system prediction model and the measurement system model established in step 103 and step 104 are substituted into the Kalman filter prediction model. The Kalman filter prediction model has formed a fixed algorithm pattern that has been widely used, which will thus not be repeated here. Then, parameters Q and R in the Kalman filter prediction model are calculated based on the prediction system noise

$$[ \begin{matrix}{n}_{1} ( i ) \\ {n}_{2} ( i )\end{matrix} ]$$

in the system prediction model and the measurement system noise v(i) in the measurement system model. The specific calculation method may adopt the covariance formula in statistics, which will not be repeated here. Finally, a prediction variable X at each moment is calculated through a conventional algorithm. That is, the tire radius r and the acceleration offset E at each moment may be estimated, and thus the corrected value of the tire radius at each moment and the corrected value of the acceleration offset at each moment may be obtained.

106: Calculate the vehicle velocity at the current moment based on the corrected value of the tire radius at the current moment and the corrected value of the acceleration offset at the current moment.

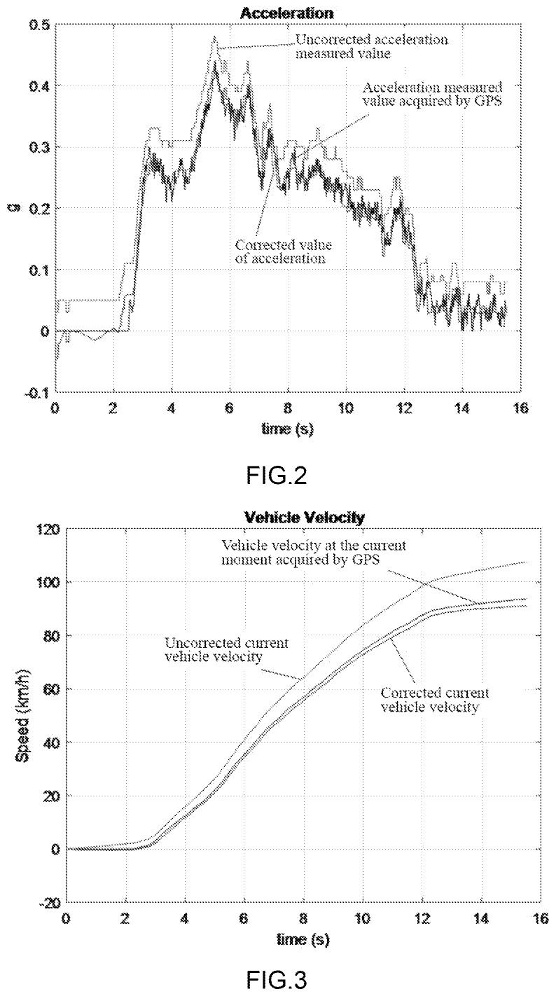

Upon obtaining the corrected value of the tire radius at the current moment and the corrected value of the acceleration offset at the current moment, the vehicle velocity at the current moment may be calculated. Specifically, a sum of (or a difference between) the acceleration measured value at the current moment and the corrected value of the acceleration offset is acquired, so an accurate corrected value a_{correction}(i) of the acceleration at this moment may be obtained. The obtained corrected value of the acceleration, the uncorrected acceleration measured value acquired by the accelerometer, and the acceleration measured value (which is considered as the accurate acceleration value) acquired by GPS are compared, as shown in FIG. 2. As can be seen from FIG. 2, there is an obvious error between the uncorrected acceleration measured value acquired by the accelerometer and the acceleration measured value acquired by GPS, while an error between the corrected value of the acceleration and the acceleration measured value acquired by GPS is very small, and the two curves are highly consistent, which indicates that, the corrected value of the acceleration is almost consistent with the acceleration measured value acquired by GPS, and the obtained corrected value of the acceleration may represent an actual acceleration value to estimate the vehicle velocity.

In order to further acquire the vehicle velocity at the current moment, the corrected value a_{correction}(i) of the acceleration at the current moment further needs to be multiplied with the sampling period T to obtain a product, and the product is added to a vehicle velocity at the previous moment to obtain a sum, the sum being the vehicle velocity at the current moment, which is specifically as shown in Formula 1 for vehicle velocity calculation.

Formula 1 for vehicle velocity calculation:

V_{CG}(i)=V_{CG}(i−1)+a_{correction}(i)*T

where V_{CG}(i) (denotes a vehicle velocity at the moment i, and V_{CG}(i−1) denotes a vehicle velocity at the moment i−1.

Of course, the vehicle velocity may be calculated in other ways, and an accurate vehicle velocity calculated value may also be obtained by directly substituting the corrected value r of the tire radius into Formula 2 for vehicle velocity calculation.

Formula 2 for vehicle velocity calculation: Vₜᵢᵣₑ=ωₜᵢᵣₑ·r

where Vₜᵢᵣₑ denotes the tire linear velocity, ωₜᵢᵣₑ denotes the tire angular velocity, and r denotes the corrected value of the tire radius.

By comparing the vehicle velocity obtained based on the corrected value of the tire radius and the corrected value of the acceleration with the uncorrected current vehicle velocity and the vehicle velocity at the current moment acquired by GPS, it is found that the vehicle velocity obtained based on the corrected value of the tire radius and the corrected value of the acceleration is more consistent with the vehicle velocity at the current moment acquired by GPS, an error between the two is smaller, and a reference value is greater, specifically as shown in FIG. 3.

According to the vehicle velocity calculation method provided by this embodiment, the specific relational expression (which is described in detail in step 102) is established by analyzing the relationship among the tire angular acceleration, the acceleration measured value, the acceleration offset, and the tire radius. The established relational expression is simply rewritten into the matrix formula (which is described in detail in step 102). The formed matrix formula may be rewritten not only into a format consistent with the standard formula of the prediction model (that is, the system prediction model), but also into a format consistent with the standard formula of the measurement model (that is, the measurement system model). Moreover, the most important thing is that the formed system prediction model and measurement system model are both consistent with the characteristics of the Kalman filter prediction model, so the variables may be just placed in the right positions, and reasonable setting of a parameter matrix is completed. This shows that it is suitable to use the Kalman filter prediction model to calculate the corrected value of the tire radius and the corrected value of the acceleration offset. Of course, in the specific experiment process, by collecting an accurate tire radius and acceleration offset, to verify the corrected value of the tire radius and the corrected value of the acceleration offset output by the Kalman filter prediction model, it is found that results output by the Kalman filter prediction model are indeed reliable and effective.

It is worth noting that in this technical solution, the Kalman filter prediction model is not the only choice to calculate the corrected value of the tire radius and the corrected value of the acceleration offset, and in actual use, a Least squares formula may also be used to replace the Kalman filter prediction model to complete the calculation. The Least squares formula is also a very mature calculation method, which will thus not be repeated here.

This embodiment discloses the high-precision vehicle velocity calculation method. In the vehicle velocity calculation method, the relational expression of the tire angular acceleration, the acceleration measured value, the acceleration offset and the tire radius at the same moment is established, the relational expression is rewritten into the matrix formula, then the system prediction model and the measurement system model are built, and the system prediction model and the measurement system model are substituted into the Kalman filter prediction model to obtain the corrected value of the tire radius and the corrected value of the acceleration offset. The obtained corrected value of the tire radius and the corrected value of the acceleration offset are highly consistent with an actual tire radius and an actual acceleration offset at the current moment, so that the vehicle velocity calculated based on the corrected value of the tire radius and the corrected value of the acceleration offset basically matches an actual vehicle velocity at the current moment, the error is small, and precision is high, which, for an advanced driving assistant system and an autonomous driving system, have a high reference value, facilitate the improvement of driving safety, reduce the probability of traffic accidents, and have a very high use value.

Apparently, the above embodiments of the present disclosure are merely examples of the present disclosure for purposes of clarity and are not intended to limit the implementations of the present disclosure. Changes or modifications in other different forms may also be made by a person of ordinary skill in the art on the basis of the above description. All implementations need not to be, and cannot be, exhaustive. Any modifications, equivalent replacements, improvements, etc. made within the spirit and principle of the present disclosure shall fall within the scope of protection of the claims of the present disclosure.

What is claimed is:

1. A high-precision vehicle velocity calculation method, comprising:
calculating a tire slip rate at the current moment, determining whether the slip rate is less than a threshold value, if the slip rate is less than the threshold value, continuing to correct a tire radius and acceleration, otherwise, stopping a correction process;
establishing a relational expression for tire angular acceleration, an acceleration measured value, an acceleration offset and a tire radius at the current moment;
building a system prediction model based on the relational expression;
building a measurement system model based on the relational expression;
substituting the system prediction model and the measurement system model into a Kalman filter prediction model, to acquire a corrected value of the tire radius at the current moment and a corrected value of the acceleration offset at the current moment; and
calculating a vehicle velocity at the current moment based on the corrected value of the tire radius at the current moment and the corrected value of the acceleration offset at the current moment.

2. The high-precision vehicle velocity calculation method according to claim 1, wherein the step of calculating the tire slip rate at the current moment comprises:
acquiring a tire linear velocity of a vehicle at the current moment;
acquiring a center point moving velocity of the vehicle at the current moment;
acquiring a difference between the tire linear velocity and the center point moving velocity;
if the vehicle is in an accelerating state at the current moment, taking the difference between the tire linear velocity and the center point moving velocity as the numerator and the tire linear velocity as the denominator to obtain a ratio of the difference to the tire linear velocity, and using the ratio as the slip rate; and
if the vehicle is in a decelerating state at the current moment, taking the difference between the tire linear velocity and the center point moving velocity as the numerator and the center point moving velocity as the denominator to obtain a ratio of the difference to the center point moving velocity, and using the ratio as the slip rate.

3. The high-precision vehicle velocity calculation method according to claim 2, wherein the step of acquiring the tire linear velocity of the vehicle at the current moment comprises:
acquiring a tire angular velocity at the current moment;
acquiring a tire factory radius; and
taking a product of the tire angular velocity at the current moment and the tire factory radius as the tire linear velocity at the current moment.

4. The high-precision vehicle velocity calculation method according to claim 1, further comprising: when the slip rate is greater than or equal to the threshold value and the correction process is stopped,
calculating the vehicle velocity at the current moment based on a corrected value of the tire radius at the previous moment and a corrected value of the acceleration offset at the previous moment.

5. The high-precision vehicle velocity calculation method according to claim 1, wherein in the step of establishing the relational expression for the tire angular acceleration, the acceleration measured value, the acceleration offset and the tire radius at the current moment, the relational expression is as follows:
$${\dot{ω}}_{tire} ( i ) = \frac{{a}_{k} ( i ) - ε ( i )}{r}$$
wherein \dot{ω}ₜᵢᵣₑ(i) denotes the tire angular acceleration, aₖ (i) denotes the acceleration measured value, ε(i) denotes the acceleration offset, and r denotes the tire radius.

6. The high-precision vehicle velocity calculation method according to claim 5, wherein after the step of establishing the relational expression for the tire angular acceleration, the acceleration measured value, the acceleration offset and the tire radius at the current moment, and before the step of building the system prediction model based on the relational expression, the method further comprises a step of formula rewriting:
rewriting the established relational expression into a matrix formula, the matrix formula being as follows:
$$\begin{matrix}{\dot{ω}}_{tire} ( i ) = [ {a}_{k} ( i ) & - 1 ]\end{matrix} [ \begin{matrix}\frac{1}{r} \\ \frac{ε ( i )}{r}\end{matrix} ]$$
wherein \dot{w}ₜᵢᵣₑ(i) denotes the tire angular acceleration, aₖ(i) denotes the acceleration measured value, ε(i) denotes the acceleration offset, and r denotes the tire radius.

7. The high-precision vehicle velocity calculation method according to claim 6, wherein the step of building the system prediction model based on the relational expression comprises:
taking
$$[ \begin{matrix}\frac{1}{r} \\ \frac{ε}{r}\end{matrix} ]$$
as a prediction variable X in the system prediction model, thereby setting
$$X = [ \begin{matrix}\frac{1}{r} \\ \frac{ε}{r}\end{matrix} ] ;$$
and
establishing, based on the matrix formula and a standard formula of a prediction model, the system prediction model specifically as follows:
$$[ \begin{matrix}\frac{1}{r} ( i ) \\ \frac{ε}{r} ( i )\end{matrix} ] = [ \begin{matrix}1 & 0 \\ 0 & 1\end{matrix} ] \cdot [ \begin{matrix}\frac{1}{r} ( i - 1 ) \\ \frac{ε}{r} ( i - 1 )\end{matrix} ] + [ \begin{matrix}{n}_{1} ( i ) \\ {n}_{2} ( i )\end{matrix} ]$$
wherein
$$[ \begin{matrix}\frac{1}{r} ( i ) \\ \frac{ε}{r} ( i )\end{matrix} ]$$
denotes X at a moment i,
$$[ \begin{matrix}\frac{1}{r} ( i - 1 ) \\ \frac{ε}{r} ( i - 1 )\end{matrix} ]$$
denotes X at a moment i−1, and
$$[ \begin{matrix}{n}_{1} ( i ) \\ {n}_{2} ( i )\end{matrix} ]$$
denotes prediction system noise.

8. The high-precision vehicle velocity calculation method according to claim 7, wherein the step of building the measurement system model based on the relational expression comprises:
taking \dot{w}ₜᵢᵣₑ(i) as a measured value Z in the measurement system model, thereby setting Z=\dot{w}ₜᵢᵣₑ(i); and
establishing, based on the matrix formula and a standard formula of a measurement model, the measurement system model specifically as follows:
$$\begin{matrix}{\dot{ω}}_{tire} ( i ) = [ {a}_{k} ( i ) & - 1 ]\end{matrix} [ \begin{matrix}\frac{1}{r} \\ \frac{ε}{r}\end{matrix} ] + v ( i )$$
wherein v(i) denotes measurement system noise.

9. The high-precision vehicle velocity calculation method according to claim 8, wherein the standard formula of the prediction model is as follows:
X(i)=A·X(i−1)+B·U(i)+N(i)
wherein X(i) denotes a state of X at the moment i, X(i−1) denotes a state of X at the moment i−1, A and B denote system parameters, U(i) denotes a system variable input at the moment i, and N(i) denotes system noise; and
the standard formula of the measurement model is as follows:
Z(i)=H·X(i)+V(i)
wherein Z(i) denotes a measured value at the moment i, X(i) denotes the state of X at the moment i, H denotes a system parameter, and V(i) denotes system noise.

10. The high-precision vehicle velocity calculation method according to claim 1, wherein the step of calculating the vehicle velocity at the current moment based on the corrected value of the tire radius at the current moment and the corrected value of the acceleration offset at the current moment comprises:
acquiring a sum of the acceleration measured value at the current moment and the corrected value of the acceleration offset, and taking the sum as a corrected value of the acceleration at the current moment; and
multiplying the corrected value of the acceleration at the current moment with a sampling period to obtain a product, and adding the product to a vehicle velocity at the previous moment to obtain a sum, the sum being the vehicle velocity at the current moment.
